(19) United States
(12) Patent Application Publication
(10) Pub. No.: US 2008/0236124 A1
(43) Pub. Date: Oct. 2, 2008

(54) Portable, Manually-Guided Implement and Shaft System Therefor

(76) Inventor: George Heinzelmann, Backnang (DE)

Correspondence Address: ROBERT W. BECKER & ASSOCIATES, 707 HIGHWAY 333, SUITE B, TIJERAS, NM, 87059-7507, US

(21) Appl. No.: 12/057,160

(22) Filed: Mar. 27, 2008

(30) Foreign Application Priority Data
Mar. 31, 2007 (DE) 10 2007 015 680.6

(51) Int. Cl. A01D 34/00; B26B 7/00

(52) U.S. Cl. 56/12.7; 30/276

(57) ABSTRACT

A shaft system for a portable, manually-guided implement, including an upper connector and a lower connector for connection to adjoining components. The shaft system has a guide tube portion and a drive shaft portion supported in the guide tube portion by at least one support bushing. The guide tube portion is made of carbon fiber reinforced polymeric material. In at least one region of the periphery of the support bushing a first spacing is formed between the support bushing and the guide tube portion, wherein the first spacing is up to approximately 15% of the inner diameter of the guide tube portion. The shaft system can be utilized with a portable, manually-guided implement.

The instant application should be granted the priority date of Mar. 31, 2007 the filing date of the corresponding German patent application 10 2007 015 680.6

### BACKGROUND OF THE INVENTION

The present invention relates to a shaft system for a portable, manually-guided implement and also relates to a portable, manually-guided implement.

US 2003/0229993 A1 discloses a tube for a trimmer or a thinning saw, on one end of which is disposed a motor and on the other end of which is disposed the working tool. Disposed in the tube is a bearing that is supported against the outer tube via ribs. The drive shaft is mounted in the bearing. The tube can be made of a fiber composite material.

A tube made of a fiber composite material can snap and thereby be destroyed already at relatively slight deformations. The advantage of a tube made of fiber composite material is the relatively light weight of this material. To achieve an adequate resistance to snapping, however, the thickness of the tube must be relatively large, thereby reducing or even eliminating the savings in weight relative to a conventional tube made of metal, such as aluminum.

It is an object of the present application to provide a shaft system for a portable, manually-guided implement that has a low weight and a high stability or rigidity. It is a further object of the invention to provide a portable, manually-guided implement having a low weight, the shaft of which has a high stability or rigidity.

### BRIEF DESCRIPTION OF THE DRAWINGS

These and other objects and advantages of the present application will be described in detail subsequently in conjunction with the accompanying schematic drawings, in which:

FIG. 1 is a perspective illustration of an implement,

FIG. 2 is a side view of the shaft extension of the implement of FIG. 1,

FIG. 3 is a cross-sectional view taken along the line III-III in FIG. 2,

FIG. 4 is an exploded view of the tool end of the shaft extension,

FIG. 5 is an enlarged view of the portion V of FIG. 3,

FIG. 6 is an enlarged cross-sectional view of the motor end of the shaft extension,

FIG. 7 is an enlarged cross-sectional view of the tool end of the shaft extension,

FIG. 8 is a cross-sectional view taken along the line VIII-VIII in FIG. 2,

FIG. 9 is a schematic illustration of the guide tube of the implement in a bent state,

FIG. 10 is a cross-sectional view taken along the line X-X in FIG. 9,

FIG. 11 is a cross-sectional view taken along the line XI-XI in FIG. 9,

FIG. 12 is a cross-sectional view taken along the line XII-XII in FIG. 9,

FIG. 13 is an exploded view of the tool end of the drive shaft,

FIG. 14 is a cross-sectional view of the tool end of the drive shaft,

FIG. 15 is a cross-sectional view of the motor end of the drive shaft,

FIG. 16 is a cross-sectional view taken along the line XVI-XVI in FIG. 14,

FIG. 17 is a cross-sectional view taken along the line XVII-XVII in FIG. 15,

FIG. 18 is an exploded view of the motor end of the drive shaft, and

FIG. 19 is a schematic side view of the motor end of the drive shaft.

### SUMMARY OF THE INVENTION

The shaft system of the present application comprises a guide tube portion that extends between a lower connector and an upper connector that are provided for connection to adjoining components. The guide tube portion is made of carbon fiber reinforced polymeric material. A drive shaft portion is supported in the guide tube portion via at least one support bushing. In at least one region of the periphery of the support bushing a first spacing is formed between the support bushing and the guide tube portion, wherein the first spacing is up to approximately 15% of the inner diameter of the guide tube portion.

The portable, manually-guided implement of the present application comprises a housing in which is disposed a drive motor; at least one tool that is driven by the drive motor; a shaft on one end of which is disposed a housing and on the opposite end of which is disposed a tool, wherein the shaft includes a guide tube and a drive shaft that is guided through the guide tube and is supported in the guide tube by at least one support bushing; at least one guide tube portion is made of carbon fiber reinforced polymeric material, and in at least one region of the periphery of the support bushing a first spacing is formed between the support bushing and the guide tube portion, wherein the first spacing is up to approximately 15% of the inner diameter of the guide tube portion.

Pursuant to the present application, carbon fiber reinforced polymeric material is used as a fiber composite material. Carbon fiber reinforced polymeric material has a low weight and can be easily produced in a pul extrusion (pull extrusion) process as a tube having a constant diameter and constant thickness. As a result of the small first spacing, when the guide tube is bent it rests against the support bushing and is thus supported from the inside. This can prevent the guide tube from being bent too severely. The support bushing is itself supported on the inside by the drive shaft. The shaft, which is built up from guide tube, support bushing and drive shaft, has a high rigidity and stability due to the support of the guide tube by means of the inwardly disposed components. The guide tube can have a relatively small wall thickness. In this connection, the shaft is designed and dimensioned in such a way that the guide tube portion rests against the support bushing and is supported thereon before the permissible deflection or bending of the guide tube portion is exceeded and a permanent deformation or destruction of the guide tube occurs. To achieve a light weight of the shaft system, the first spacing should be up to approximately 15% of the inner diameter of the guide tube portion. The shaft system is advantageously a shaft extension.

The first spacing is advantageously up to approximately 10% of the inner diameter of the guide tube portion. The first spacing is expediently at least 5% of the inner diameter of the guide tube portion.

To achieve a good support of the drive shaft, the support bushing can be supported against the guide tube portion via at least one support element. The region in which the first spacing exists is disposed in particular between two support elements of the support bushing. A plurality of support elements are advantageously provided and are disposed on the periphery of the support bushing in such a way that one support element is disposed opposite each region, in other words on the opposite side of the periphery that is disposed between two support elements. This ensures that two regions in which the first spacing exists between guide tube and support bushing cannot be disposed across from one another. Thus, when the guide tube is bent it rests against a support element and an oppositely disposed region in which a spacing exists between guide tube and support bushing.

A second spacing of approximately 0.2% to approximately 2% of the inner periphery or diameter of the guide tube portion can be formed between the support element and the guide tube portion. Due to the small spacing between the support element and guide tube portion, the stability of the guide tube is further increased. The support bushing advantageously has a cylindrical main body, from the outer periphery of which at least one support element extends outwardly, whereby the drive shaft portion is supported in the main body. A third spacing, which is approximately 0.5% to approximately 4% of the inner diameter of the guide tube portion, can be formed between the outer periphery of the drive shaft portion and the main body of the support bushing. Due to the fact that the spacing is approximately 0.5% or more of the inner diameter of the guide tube portion, a low friction lubrication and support of the drive shaft portion is ensured. Furthermore, the relatively small spacing ensures that upon deformation of the shaft the guide tube is supported against the drive shaft via the support bushing. The drive shaft portion thereby increases the stability of the guide tube portion.

The first, second and third spacings are measured in a radial direction and in a centered positioning of the elements relative to one another. The given spacings are thereby one half of the difference of the respective diameters of the corresponding components.

The support bushing advantageously extends over the entire length of the guide tube portion between the upper connector and the lower connector. The position of the drive shaft portion can thereby easily be secured in the guide tube portion.

To easily enable a connection of the shaft system with adjoining shaft portions, at least one end of the drive shaft portion can be fixedly or positively connected with a connection element. In this connection, the connection element can have a receiving means for a coupling element, or directly establish a coupling to an adjoining connection element. The drive shaft portion can have an inner profile that engages in an outer profile of the connection element. In this way it is easily possible to achieve a reliable and positive connection between the drive shaft portion and the connection element.

In a region that is inserted into the drive shaft portion the connection element advantageously has a first outer diameter and a second outer diameter, whereby the first outer diameter is greater than an associated first inner diameter of the drive shaft portion prior to the insertion of the connection element, and the second outer diameter is less than an associated second inner diameter of the drive shaft portion prior to the insertion of the connection element. Due to the fact that the connection element in one region has a larger outer diameter and in another region has a smaller outer diameter than the drive shaft portion, the connection element deforms the drive shaft portion during pressing of the connection element of the connection element into the drive shaft portion. It is thus possible to easily achieve a fixed or positive connection between the connection element and the drive shaft portion. Since a second outer diameter of the connection element is less than the associated second inner diameter of the drive shaft portion, the drive shaft portion is deformed without the necessity for an expansion over the entire periphery. As a result, the force required to press the connection element in is reduced. Different diameters in different regions can be provided with profiled connection element and profiled drive shaft portion; however, the different diameters can also be provided with non-profiled surfaces. It would also be possible to provide only the connection element, or only the drive shaft portion, with a profile. Different outer contours can also be provided. For example, the connection element can have an oval cross-section, and the drive shaft portion can have a round cross-section. The two regions with the first and second outer diameters are advantageously disposed in one cross-section.

To increase the stability of the end regions of the shaft system, a reinforcing sleeve that surrounds the guide tube portion can be disposed adjacent to at least one connection element. The guide tube portion and the drive shaft portion can respectively be embodied as a one-part tube that extends from the lower connector to the upper connector. Due to the fact that the guide tube portion extends over the entire length of the shaft system between the upper and the lower connectors, a great length of the guide tube portion results. Due to the great length of the guide tube portion, a support on the support bushing during deformation is advantageous. Due to the relatively great length of the guide tube portion, the guide tube of a manually-guided implement can be composed of few portions. Advantageously, for normal working heights only one shaft system, which is advantageously embodied as a shaft extension, is required.

As mentioned previously, for the portable, manually-guided implement as described, where the shaft includes a guide tube and a drive shaft, and where the drive shaft is guided through the guide tube and is supported in the guide tube by at least one support bushing, at least one guide tube portion is made of carbon fiber reinforced polymeric material, and in at least one region of the periphery of the support bushing a first spacing is formed between the support bushing and the guide tube portion, wherein the first spacing is up to approximately 15% of the inner diameter of the guide tube portion. Due to the small spacing between support bushing and guide tube portion, upon deformation the guide tube portion rests against the support bushing, thus being supported by the support bushing. As a result, the guide tube can have a small wall thickness yet high stability, resulting in a low weight of the implement.

The first spacing is advantageously up to about 10% of the inner diameter of the guide tube portion. In particular, the first spacing is at least 5% of the inner diameter of the guide tube portion. The guide tube, in other words with a one-piece guide tube the entire guide tube, and with a multi-part guide tube the individual guide tube portions, are advantageously entirely made of carbon fiber reinforced polymeric material. The individual guide tube portions of a multi-part guide tube are advantageously made of tube material that is cut to length. All of the guide tube portions thereby advantageously have the same outer diameter and inner diameter, as well as the same thickness.

The support bushing is advantageously supported on the guide tube via at least one support element. The region in which the first spacing exists is expediently disposed between two support elements of the support bushing. In particular, a plurality of support elements are provided that are disposed on the periphery of the support bushing in such a way that a support element is disposed opposite each region that is disposed between two support elements. A second spacing of approximately 0.2% to approximately 2% of the inner periphery of the guide tube is advantageously formed between the support bushing and the guide tube.

The support bushing can have a cylindrical main body, from the outer periphery of which at least one support element extends outwardly, whereby the drive shaft is supported in the main body. The third spacing, which is approximately 0.5% to approximately 4% of the inner diameter of the guide tube, is advantageously formed between the outer periphery of the drive shaft and the main body of the support bushing.

The drive shaft can have a multi-part configuration. This enables a simple transport of the implement. For the connection of the drive shaft portions, at least one connector element is advantageously provided that is fixedly or positively connected with a drive shaft portion. The drive shaft portion advantageously has an inner profile that engages in an outer profile of the connection element. In a region inserted into the drive shaft portion the connection element advantageously has a first outer diameter and a second outer diameter, whereby the first outer diameter is greater than an associated first inner diameter of the drive shaft portion prior to the insertion of the connection element, and the second outer diameter is less than an associated second inner diameter of the drive shaft portion prior to the insertion of the connection element.

The implement in particular has a shaft system that advantageously is a shaft extension. A plurality of shaft extensions can also be provided. Consequently, the length of the shaft of the implement can be adapted to a respective application. The shaft system, in particular the shaft extension, due to the configuration of the guide tube of carbon fiber reinforced polymeric material, has a low weight and due to the small spacing between guide tube and support bushing has a high stability.

Further specific features and advantages of the present application will be described in detail subsequently.

### DESCRIPTION OF SPECIFIC EMBODIMENTS

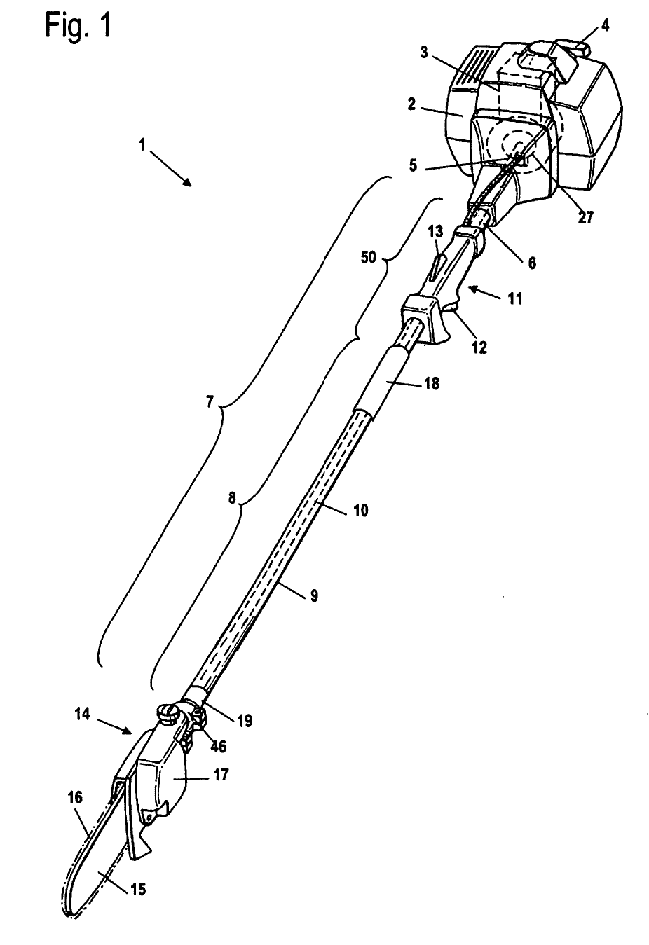

Referring now to the drawings in detail, the portable, manually-guided implement 1 shown in FIG. 1 is embodied as a pole pruner. The implement 1 has a housing 2 in which is disposed the drive motor 3, which is schematically indicated in FIG. 1 and is embodied as an internal combustion engine. The drive motor 3 is, in particular, a single cylinder motor, advantageously a 2-cycle motor or a mixture-lubricated 4-cycle motor. Extending out of the housing 2 is a starter or pull grip 4 of a starter device for starting the drive motor 3. The drive motor 3 rotatably drives a drive shaft 5, and is coupled to the drive shaft via a coupling or clutch 27.

Secured in position on the housing 2 is a shaft 7 that connects the housing 2 to the gear mechanism housing 14. The shaft 7 includes a guide tube 6, which extends from the housing 2 to the gear mechanism housing 14, as well as the drive shaft 5, which is rotatably mounted in the guide tube 6. Disposed in the gear mechanism housing 14 is a non-illustrated gear mechanism, via which the drive shaft 5 drives a tool, namely a saw chain 16 that is schematically indicated in FIG. 1 and circulates on a guide bar 15. For the lubrication of the saw chain 16, a lubricant tank 17 is secured to the gear mechanism housing 14.

A handgrip 11 is secured to the shaft 7 adjacent to the housing 2 for holding and guiding the implement 1; a gas throttle trigger 12 and a throttle lock 13 are mounted on the handgrip 11. The drive motor 3 is capable of being operated by the throttle trigger 12. Other or further control elements can also be provided on the handgrip 11.

The shaft 7 has a multi-part construction and includes a lower shaft portion 50, which is secured to the housing 2, as well as a shaft extension 8, which extends between the lower shaft portion 50 and the gear mechanism housing 14. The shaft extension 8 represents a shaft system. Other shaft systems could also be provided that are not embodied as an extension, for example shaft systems that form the entire shaft. A plurality of shaft extensions 8 could also be provided. The shaft extension 8 has a lower, motor end connector 18 for connection to the lower shaft portion 50, as well as an upper, tool end connector 19 for connection to the gear mechanism housing 14. The upper connector 19 can also be provided for connection to a further guide tube portion. A guide tube portion 9, in which is rotatably mounted a drive shaft portion 10, extends between the two connectors 18 and 19. The guide tube 6 and the drive shaft 5 thus have a multi-part construction over their length. The configuration provided for the shaft 7 can also be advantageous for a drive unit, the drive shaft of which is reciprocably driven. The upper, tool end connector 19 is connected to a clamping sleeve 46 of the gear mechanism housing 14. The guide tube portion 9 has an outer diameter n that is constant over the entire length of the guide tube portion 9. The outer diameter n advantageously corresponds to the outer diameter of the guide tube 6 in the lower shaft portion 50.

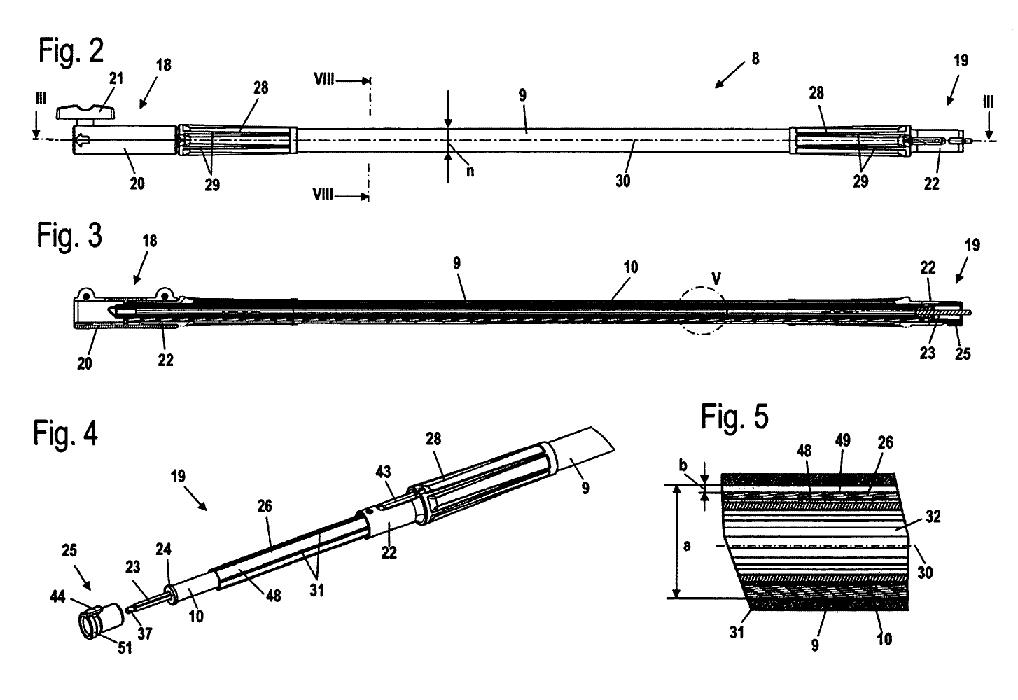

In FIGS. 2 and 3, the shaft extension 8 is shown with a guide tube portion 9. The motor end connection 18 includes a clamping sleeve 20 that can cooperate with a non-illustrated insertion sleeve of the lower shaft portion 50 or with an insertion sleeve 22 of the tool end connector 19 of a further shaft extension 8. A tightening screw 21 is provided for the fixation and release of the clamping sleeve 20. As shown in FIG. 3, the clamping sleeve 20 is held on an insertion sleeve 22 of the motor end connector 18. The insertion sleeve 22 is monolithically formed with a reinforcing sleeve 28, which extends from the insertion sleeve 22 in a direction toward the middle of the guide tube portion 9, and surrounds the outer side of the guide tube portion 9 over a portion of its length. To increase the stability, provided on the outer side of the reinforcing sleeve 28 are ribs 29 that extend radially outwardly and in the longitudinal direction of the guide tube portion 9. The component that includes the insertion sleeve 22 and the reinforcing sleeve 28 is disposed not only at the motor end connector 18 but also at the tool end connector 19. Due to the identical configuration, the number of components that are required can be reduced. As shown in FIG. 3, a guide sleeve 25 is inserted into the insertion sleeve 22 of the tool end connector 19. At the tool end of the drive shaft portion 10, the drive shaft is connected to a polygonal shaft 23. As shown in FIG. 4, in the illustrated embodiment the polygonal shaft 23 has a quadratic cross-section. Disposed on the outwardly projecting end of the polygonal shaft 23 is a centering pin 37.

As shown in FIG. 4, the guide sleeve 25 has a rim 51, the outer periphery of which corresponds approximately to the outer periphery of the insertion sleeve 22, and which rests against the insertion sleeve 22. Upon connection with adjacent portions of the guide tube 6, the rim 51 forms an abutment surface.

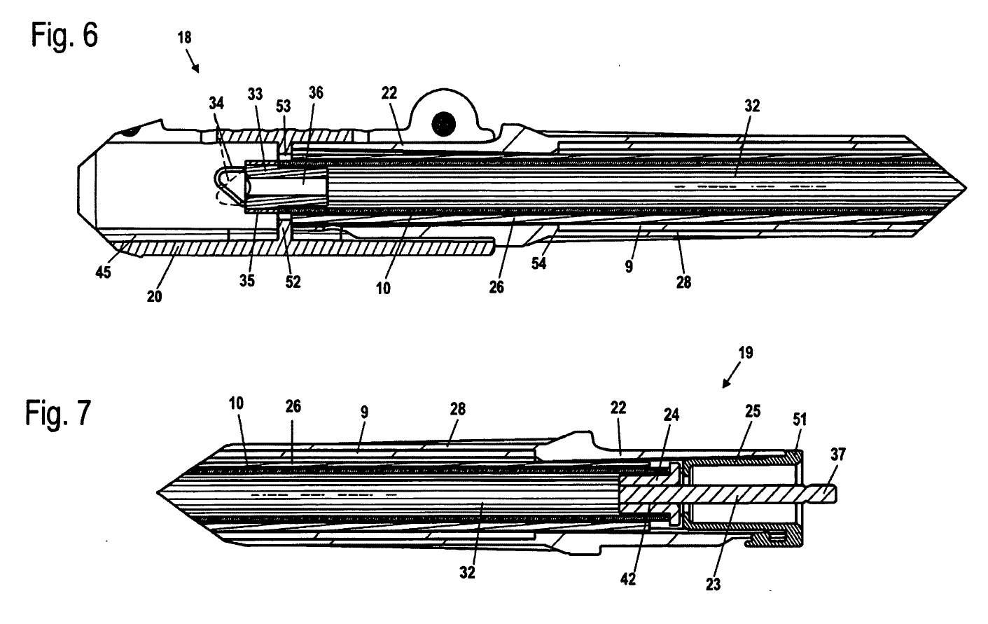

As also shown in FIG. 4, the guide sleeve 25 has a radially outwardly extending raised portion 44 that extends in the direction of the longitudinal central axis 30 of the shaft extension 8, which is shown in FIG. 2. Also formed on the insertion sleeve 22 is a raised portion 43 that extends parallel to the longitudinal central axis 30. Upon connection with an adjoining portion of the guide tube 6, the raised portions 43 and 44 come to rest in a recess 45 of the clamping sleeve 20 which is shown in FIG. 6.

As shown in FIG. 4, the polygonal shaft 23 is held in a tool end connection element 24 that is inserted into the drive shaft portion 10. A support bushing 26 is provided for holding or seating the drive shaft portion 10 in the guide tube portion 9; the support bushing 26 extends over nearly the entire length of the drive shaft portion 10. The support bushing 26, which is also designated a liner, has a main body 48 that essentially has a cylindrical configuration. Projecting radially outwardly from the main body 48 are support elements 31, which in particular are formed as fins or ribs. In the illustrated embodiment, the fins 31 extend radially outwardly and parallel to the longitudinal central axis 30 of the shaft extension 8. However, other configurations of the support element 31 can also be advantageous.

Formed between the inner wall of the guide tube portion 9 and the main body 48 of the support bushing 26 is the first spacing b, which is shown in FIG. 5. The first gap or spacing b is about 5% to about 15% of the inner diameter a of the guide tube portion 9. The first spacing b is in particular from about 5% to about 10% of the inner diameter a of the guide tube portion 9. It can be advantageous for the first spacing b to be less than 5% of the inner diameter a of the guide tube portion 9. Disposed across from the region 49 of the support bushing 26 at which the first spacing b is formed is a support element 31 for support at the inner side of the guide tube portion 9. The first spacing b is measured with a central arrangement of the drive shaft portion 10, support bushing 26 and guide tube portion 9, in other words, when the longitudinal central axes of the individual elements coincide with the longitudinal central axis 30 of the shaft extension 8.

In FIGS. 6 and 7, the motor end connector 18 and the tool end connector 19 are shown enlarged. As shown in FIG. 6, the clamping sleeve 20 has a partition 52, against which the insertion sleeve 22 and the support bushing 26 rest. The partition 52 has a central opening 53 through which extends the drive shaft portion 10. Inserted into the drive shaft portion 10 is a motor end connection element 33 that is provided with a central receiving means 36 for a polygonal shaft 23. To facilitate the insertion of the polygonal shaft 23, two guide yokes 34 are secured to the motor end connection element 33 via a securing sleeve 35. The guide yokes 34 rotate the profile of the polygonal shaft 23 into the correct position during insertion. The guide tube portion 9 rests against a shoulder 54 formed in the insertion sleeve 22.

The tool end connection element 24 is provided on the tool end connector 19 shown in FIG. 7; the tool end connection element 24 has a central opening or receiving means 42 for the polygonal shaft 23. The openings or receiving means 36 and 42 in the connection elements 24 and 33 have a profile that corresponds to the polygonal shaft 23; in the illustrated embodiment, the receiving means 36 and 42 are thus configured with a quadratic cross-section.

With a multi-part drive shaft 5, in other words a drive shaft composed of a plurality of guide tube portions 9, all connectors 18 and 19 are configured in conformity with the connectors 18 and 19 shown in FIGS. 6 and 7. When the connectors 18, 19 of adjacent guide tube portions 9 are assembled, the insertion sleeve 22 of a tool end connector 19 of the adjacent guide tube portion 9 comes to rest in the clamping sleeve 20 of a motor end connector 18 of the adjacent guide tube portion 9. The polygonal shaft 23 is secured in the tool end connection element 24 and is inserted into the motor end connection element 33 to such an extent until the rim 51 of the guide sleeve 25 rests against the partition 52. The tightening screw 21 is subsequently tightened, and the clamping sleeve 20 is fixed.

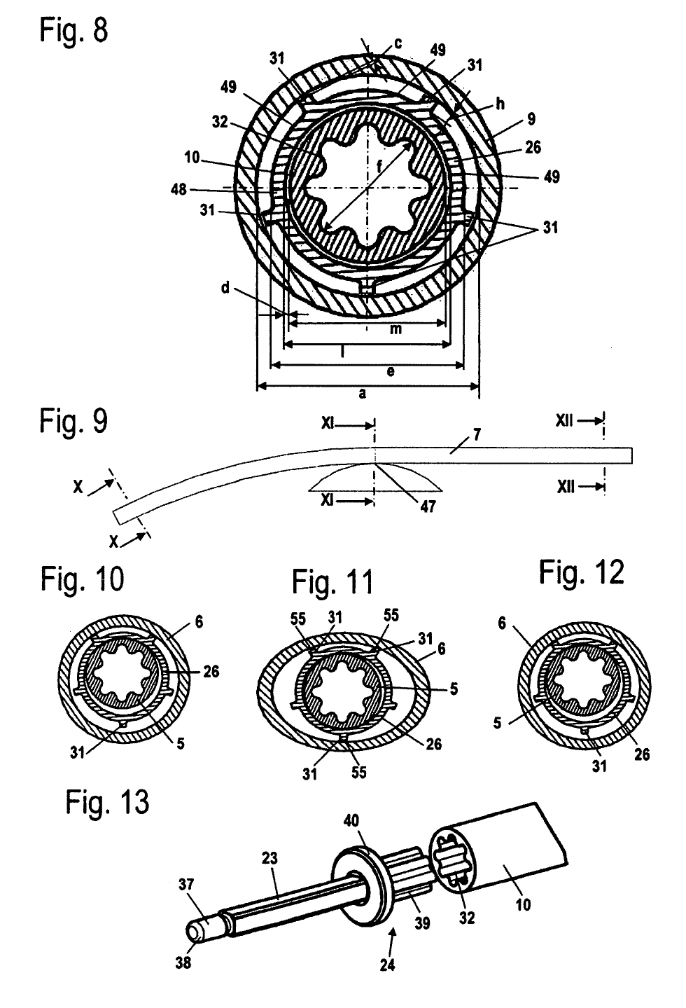

The drive shaft 5, together with the drive shaft portion 10, is advantageously made of metal, especially aluminum. The support bushing 26 is advantageously made of polymeric material. To achieve a low weight of the implement 1, the guide tube 6, together with the guide tube portion 9, is formed entirely of carbon fiber reinforced polymeric material. To achieve a high stability of the guide tube 6 despite the relatively low rigidity of the carbon fiber reinforced polymeric material, the dimensions shown in FIG. 8 are provided that alone, and in combination with one another, lead to a support of the guide tube 6 by means of the drive shaft 5 and the support bushing 26, thereby increasing the overall rigidity.

The illustrated dimensions can be provided in a prescribed portion of the guide tube 6 that is particularly stressed. However, it can also be provided that all portions of the shaft 7 that are provided with the guide tube 6, the support bushing 26 as well as the drive shaft 5 are correspondingly embodied, and only those regions that serve for the connection of adjacent portions of guide tube 6 and drive shaft 5 be embodied in a different manner, for example as shown in FIGS. 6 and 7. All portions of the guide tube 6 are advantageously formed from the same, tubular pole material so that all portions have the same outer and inner diameters as well as the same thicknesses.

As the cross-section shown in FIG. 8 through the guide tube portion 9 of the shaft extension 8 shows, the support bushing 26 has a total of five support elements 31, which extend radially outwardly and have a height h. The height h is slightly less than half the difference between the inner diameter a of the guide tube portion 9 and the outer diameter e of the main body 48 of the support bushing 26. As a result, a second spacing c is formed between the support elements 31 and the guide tube portion 9; the second spacing or gap c is from approximately 0.2% to approximately 2% of the inner periphery or diameter a of the guide tube portion 9. The second spacing c is advantageously from about 0.5% to 1.5% of the inner periphery a of the guide tube portion 9. This very slight second spacing c ensures that already with a slight deformation the guide tube portion 9 is supported on the support elements 31. The small second spacing c serves to compensate for tolerances, so that the implement 1, and in particular the shaft extension 8, can be produced in a straightforward manner.

The five support elements 31 are uniformly disposed on the periphery of the main body 48. Respectively disposed between each two support elements 31 is a region 49 in which the main body 48 has the first spacing b relative to the inner periphery of the guide tube portion 9 as shown in FIG. 5. Due to the uniform arrangement of the five support elements 31, disposed opposite or across from each region 49 on the periphery is a support element 31. As a result, deformation of the guide tube 6 is kept low, since no two regions 49 are disposed diametrically across from one another. At the same time, the outer diameter e of the main body 48 of the support bushing 26 can be kept to a minimum. Consequently, the outer diameter n of the drive shaft 5, in other words the drive shaft portion 10, can also be kept relatively small, thus resulting in a low weight of the implement 1. Formed between the outer diameter n of the drive shaft portion 10 and the inner diameter I of the support bushing 26 is a third spacing d, which is advantageously approximately 0.5% to approximately 4% of the inner diameter a of the guide tube portion 9. The third spacing or gap d is advantageously about 1.5% to about 3% of the inner diameter a.

As shown in FIG. 8, the drive shaft portion 10 has an inner profile 32 that has a wave-shaped configuration. The inner profile 32 is also shown in FIGS. 5 to 7. The wave-shaped profile permits a simple, fixed or positive connection of adjacent drive shaft portions 10, and a simple fixed or positive connection with the gear mechanism of the implement 1. As shown in FIG. 8, the drive shaft portion 10 has an inner diameter f as measured between oppositely disposed wave troughs or valleys of the inner profile 32.

FIG. 8 illustrates the configuration of the shaft 7 in the region of the shaft extension 8. However, the shaft 7 can have a corresponding configuration in all regions. In particular, a corresponding configuration is also advantageous with a shaft 7 where the guide tube and drive shaft each have a monolithic construction, and extend from the housing 2 up to the gear mechanism housing 14.

FIG. 9 schematically shows the bending of the shaft 7 when the shaft makes contact with or engages a bearing surface 47. As shown in FIG. 9, the shaft 7 bends or deflects. Since the guide tube 6 is made of carbon fiber reinforced polymeric material, no great deflection of the guide tube 6 is permissible. If a greater bending were to take place, the guide tube 6 would snap and hence be destroyed. An impermissibly great bending is prevented in that when the guide tube 6 bends, it is supported against the support bushing 26 and the drive shaft 5 or drive shaft portion 10. This leads to an increased rigidity.

FIGS. 10 to 12 show the position of the drive shaft 5, the guide tube 6 and the support bushing 26 in various regions of the shaft 7. As shown in FIGS. 10 and 12, in the outer regions of the shaft 7, in other words the regions shown in FIGS. 10 and 12, that are remote from the bearing surface 47, at the bend outer sides of the shaft 7 the guide tube 6 rests against the support bushing 26 and presses the support bushing against the drive shaft 5. At the opposite, bend inner sides of the shaft 7 a gap or spacing is formed not only between the drive shaft 5 and the support bushing 26, but also between the support elements 31 of the support bushing 26 and the inner side of the guide tube 6.

As shown in FIG. 11, the guide tube 6 is deformed in the region of the bearing surface 47. In particular, the guide tube 6 assumes a flat, approximately elliptical shape and on opposite sides is supported on support elements 31 of the support bushing 26. In the illustrated embodiment, on the bend outer side of the shaft 7 the guide tube 6 is supported at two support points 55, and on the bend inner side of the shaft 7 is supported at an opposite support point 55. Even on the bend outer side the guide tube 6 does not come to rest against the main body 48 of the support bushing 26. However, the shaft 7 can also be designed in such a way that with an appropriate bending the guide tube 6 rests against the main body 48 and is supported thereon. The support bushing 26 is also slightly deformed and rests against the drive shaft 5 on the bend outer side and on the bend inner side. Due to this engagement, the inner periphery of the guide tube 6 is supported and cannot be compressed any further.

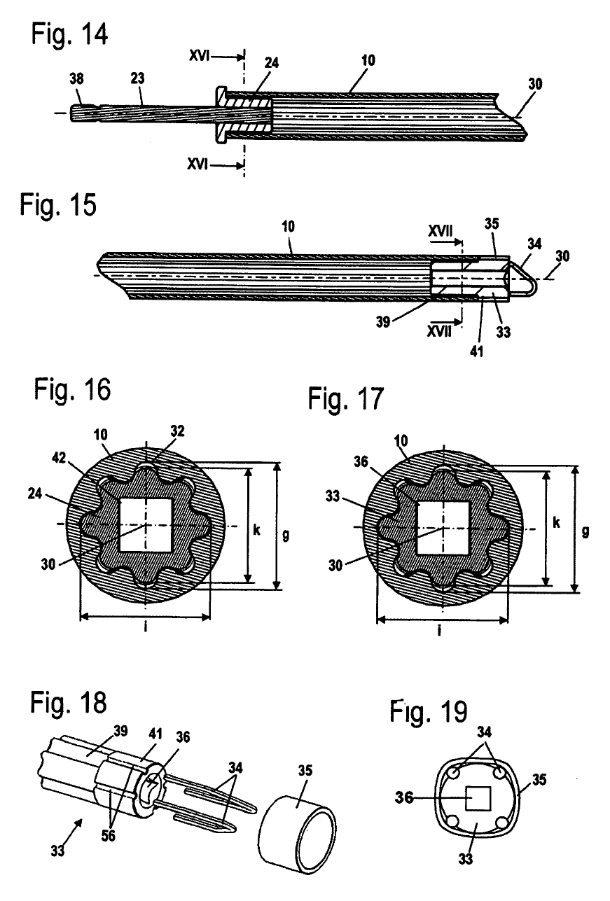

FIGS. 13 to 17 show the connection of the connection elements 24 and 33 with the drive shaft portion 10. As shown in FIG. 13, the connection element 24 has an outer profile 39 that corresponds to the inner profile 32 of the drive shaft portion 10. The connection element 24 is additionally provided with a rim 40 that, when the connection element 24 is inserted, comes to rest against the end face of the drive shaft portion 10. As shown in FIG. 13, the front end of the centering pin 37, in other words that end that projects toward the adjacent connection element 33, is provided with a beveling 38 that facilitates insertion of the centering pin 37.

To achieve a fixed connection between the connection element 24 and the drive shaft portion 10, the outer profile 39 of the connection element 24 does not completely coincide with the inner profile 32 of the drive shaft portion 10. In particular, as shown in FIG. 16, the outer profile 39 of the connection element 24 has a first diameter i that is greater than the inner diameter f of the drive shaft portion 10 shown in FIG. 8. In this connection, the outer diameter i is measured between two wave peaks, and the inner diameter f is measured between pertaining waves troughs of the drive shaft portion 10. In a region rotated by 90° about the longitudinal central axis 30, the connection element 24 has a second outer diameter k, which is less than the associated inner diameter f of the inner profile 32 of the drive shaft portion 10. Upon pressing in of the connection element 24, the drive shaft portion 10 is thereby widened in the region of the first outer diameter i. In the region of the second diameter k, the drive shaft portion 10 can be become narrower, so that a reduced inner diameter 9 results in this region. The inner diameter g is somewhat less than the inner diameter f in a central region of the drive shaft portion 10 or prior to the pressing in of the connection element 24.

The motor end connection element 33 shown in FIGS. 15 and 17 has a corresponding configuration and is also provided with a first, enlarged diameter i and a second, reduced diameter k. In a corresponding manner, the drive shaft portion 10 is also widened in the region of the first diameter i upon pressing in of the motor end connection element 33, and can flatten in the region of the second diameter k, resulting in a reduced inner diameter g. Consequently, in the region of the connection elements 24 and 33 the drive shaft portion 10 is not entirely round, but rather has a slightly oval cross-section.

A good press connection can also be achieved with other cross-sectional shapes. For this purpose, the component that is to be pressed in, and the component into which insertion is to be achieved, must have different cross-sections that are suitably adapted to one another. For example, a tubular component having a round inner diameter, and a component that is to be pressed in having a slightly oval outer diameter, can be provided. The connection of the guide members or yokes 34 with the connection element 33, which is shown in FIGS. 18 and 19, can also be effected pursuant to the same principle. Here a securing sleeve 35 is provided for the fixation. The guide yokes 34 are disposed in grooves 56 of the connection element 33. The grooves 56 are disposed in a rim 41 of the connection element 33 that, as shown in FIG. 15, presses against the end face of the drive shaft portion 10 when the connection element 33 is pressed in.

As shown in FIG. 19, the yokes 34 are fixed against the connection element 33 by means of the securing sleeve 35. The connection element 33 has a non-symmetrical cross-section in conjunction with the yokes 34. As a result, the securing sleeve 35 is widened in the region of the guide yokes 34 and rests against the connection element 33 in the regions that are respectively disposed between each two guide yokes 34.

To ensure that the securing sleeve 35, or the ends of the drive shaft portion 10, are widened, the connection elements 33 and 24 can be made of a material that is harder than the drive shaft portion 10 and the securing sleeve 35. The connection elements 24 and 33 are advantageously made of a sintered material, while the drive shaft portion 10 and the securing sleeve 35 are made in particular of metal. The securing sleeve 35 is advantageously made of steel, and the drive shaft 5 and drive shaft portion 10 are advantageously made of aluminum.

Due to the fact that the drive shaft portion 10 and the securing sleeve are widened, tolerances can be compensated for during the pressing-in process. As a result, a fixed press connection can be ensured in a straightforward manner. The described design of a press connection represents an independent inventive concept and can also be used with press connections for other applications. Thus, the use of such a press connection is not limited to manually guided implements.

The guide tube 6 and the drive shaft 5 have a constant diameter from the housing 2 up to the gear mechanism housing 14. Where the guide tube 6 and/or the drive shaft 5 have a multi-part configuration, the individual portions are embodied with the same, constant diameter.

In the illustrated embodiment the inner diameter a of the guide tube 6 or the guide tube section 9 is approximately 21 mm, the first spacing b is approximately 3 mm, the second spacing c is approximately 0.4 mm, and the third spacing d is approximately 1 mm. The outer diameter n of the guide tube 6 and of the guide tube section 9 is advantageously approximately 25 to 26 mm.

The specification incorporates by reference the disclosure of German priority document 10 2007 015 680.6 filed Mar. 31, 2007.

The present invention is, of course, in no way restricted to the specific disclosure of the specification and drawings, but also encompasses any modifications within the scope of the appended claims.

What I claim is:

1. A shaft system for a portable, manually-guided implement, comprising:
a first connector (18) for connection to adjoining components;
a second connector (19) for connection to adjoining components;
a guide tube portion (9) extending between said first and second connectors (18, 19), wherein said guide tube portion (9) is made of carbon fiber reinforced polymeric material;
a drive shaft portion (10) disposed in said guide tube portion (9); and
at least one support bushing (26), wherein said drive shaft portion (10) is supported in said guide tube portion (9) via said at least one support bushing (26), further wherein in at least one region (49) of a periphery of said at least one support bushing (26) a first spacing (b) is formed between said at least one support bushing (26) and said guide tube portion (9), and wherein said first spacing (b) is up to approximately 15% of an inner diameter (a) of said guide tube portion (9).

2. A shaft system according to claim 1, wherein said first spacing (b) is up to approximately 10% of said inner diameter (a) of said guide tube portion (9).

3. A shaft system according to claim 1, wherein said first spacing (b) is at least approximately 5% of said inner diameter (a) of said guide tube portion (9).

4. A shaft system according to claim 1, wherein said at least one support bushing (26) is supported on said guide tube portion (9) via at least one support element (31), and wherein said region (49) in which said first spacing (b) exists is disposed between two of said support elements (31) of said at least one support bushing (26).

5. A shaft system according to claim 4, wherein a plurality of support elements (31) are provided and are disposed on the periphery of said at least one support bushing (26) in such a way that a support element (31) is disposed across from each of said regions (49) disposed between two of said support elements (31).

6. A shaft system according to claim 4, wherein a second spacing (c) is formed between a support element (31) and said guide tube portion (9), and wherein said second spacing (c) is approximately 0.2% to approximately 2% of said inner diameter (a) of said guide tube portion (9).

7. A shaft system according to claim 4, wherein said at least one support bushing (26) has a cylindrical main body (48), further wherein at least one support element (31) extends outwardly from an outer periphery of said main body (48), further wherein said drive shaft portion (10) is supported within said main body (48), further wherein a third spacing (d) is formed between an outer periphery of said drive shaft portion (10) and said main body (48) of said at least one support bushing (26), and wherein said third spacing (d) is approximately 0.5% to approximately 4% of said inner diameter (a) of said guide tube portion (9).

8. A shaft system according to claim 1, wherein said at least one support bushing (26) extends over the entire length of said guide tube portion (9) between said first connector (18) and said second connector (19).

9. A shaft system according to claim 1, wherein a connection element (24, 33) is positively connected to at least one end of said drive shaft portion (10), and wherein said drive shaft portion (10) has an inner profile (32) that engages in an outer profile (39) of said connection element (24, 33).

10. A shaft system according to claim 9, wherein in a region adapted to be inserted into said drive shaft portion (10), said connection element (24,33) has a first outer diameter (i) and a second outer diameter (k), further wherein said first outer diameter (i) is greater than an associated first inner diameter (f) of said drive shaft portion (10) prior to insertion of said connection element (24, 33), and wherein said second outer diameter (k) is less than an associated second inner diameter (f) of said drive shaft portion (10) prior to insertion of said connection element (24, 33).

11. A shaft system according to claim 1, wherein a reinforcing sleeve (28) that is adapted to surround said guide tube portion (9) is disposed adjacent to at least one of said first and second connectors (18, 19).

12. A shaft system according to claim 1, wherein said guide tube portion (9) and said drive shaft portion (10) are each embodied as a one-piece tube that extends from said first connector (18) to said second connector (19).

13. A portable, manually-guided implement, comprising:
a housing (2) in which is disposed a drive motor (3);
at least one tool adapted to be driven by said drive motor (3);
a shaft (7) having a first end on which said housing (2) is disposed and a second opposite end on which said at least one tool is disposed, wherein said shaft (7) includes a guide tube (6) and a drive shaft (5) that is guided through said guide tube (6), and wherein at least one portion (9) of said guide tube (6) is made of carbon fiber reinforced polymeric material; and
at least one support bushing (26), wherein said drive shaft (5) is supported in said guide tube (6) via said at least one support bushing (26), further wherein in at least one region (49) of a periphery of said at least one support bushing (26) a first spacing (b) is formed between said at least one support bushing (26) and said one guide tube portion (9), and wherein said first spacing (b) is up to approximately 15% of an inner diameter (a) of said one guide tube portion (9).

14. An implement according to claim 13, wherein said first spacing (b) is up to approximately 10% of said inner diameter (a) of said one guide tube portion (9).

15. An implement according to claim 13, wherein said first spacing (b) is at least approximately 5% of said inner diameter (a) of said one guide tube portion (9).

16. An implement according to claim 13, wherein said guide tube (6) is made entirely of carbon fiber reinforced polymeric material.

17. An implement according to claim 13, wherein said at least one support bushing (26) is supported in said guide tube (6) via at least one support element (31), and wherein said region (49) in which said first spacing (b) exists is disposed between two support elements (31) of said at least one support bushing (26).

18. An implement according to claim 17, wherein a plurality of support elements (31) are provided, and wherein said support elements (31) are disposed on the periphery of said at least one support bushing (26) in such a way that a support element (31) is disposed across from each region (49) disposed between two support elements (31).

19. An implement according to claim 17, wherein a second spacing (c) is formed between said support element (31) and said guide tube (6), and wherein said second spacing (c) is from approximately 0.2% to approximately 2% of said inner diameter (a) of said one guide tube portion (9).

20. An implement according to claim 17, wherein said at least one support bushing (26) has a cylindrical main body (48), further wherein at least one support element (31) extends outwardly from an outer periphery of said main body (48), further wherein said drive shaft (5) is supported within said main body (48), further wherein a third spacing (d) is formed between the outer periphery of the drive shaft (5) and the main body (48) of said at least one support bushing (26), and wherein said third spacing (d) is approximately about 0.5% to approximately 4% of said inner diameter (a) of said one guide tube portion (9).

21. An implement according to claim 13, wherein said drive shaft has a multi-part configuration, further wherein for connection of the drive shaft portions (10) at least one connection element (24, 33) is provided that is positively connected with one of said drive shaft portions (10), and wherein said one drive shaft portion (10) has an inner profile (32) that engages into an outer profile (39) of said connection element (24, 33).

22. An implement according to claim 21, wherein in a region inserted into said drive shaft portion (10) said connection element (24, 33) has a first outer diameter (i) and a second outer diameter (k), further wherein said first outer diameter (i) is greater than an associated first inner diameter (f) of said drive shaft portion (10) prior to insertion of said connection element (24, 33), and wherein said second outer diameter (k) is less than an associated second inner diameter (f) of said drive shaft portion (10) prior to said insertion of said connection element (24, 33).

23. An implement according to claim 13, wherein said shaft (7) comprises said shaft system of claim 1.
